(19) United States
(12) Patent Application Publication
(10) Pub. No.: US 2026/0121154 A1
(43) Pub. Date: Apr. 30, 2026

(54) PACK HOUSING AND BATTERY PACK INCLUDING THE SAME

(71) Applicant: LG ENERGY SOLUTION, LTD., Seoul (KR)

(72) Inventors: Kwang Mo KIM, Daejeon (KR); Hye Mi JUNG, Daejeon (KR); Jung Hoon LEE, Daejeon (KR); Joo Hyoung LEE, Daejeon (KR)

(73) Assignee: LG ENERGY SOLUTION, LTD., Seoul (KR)

(21) Appl. No.: 19/308,804

(22) Filed: Aug. 25, 2025

(30) Foreign Application Priority Data
Oct. 31, 2024 (KR) 10-2024-0152250

(51) Int. Cl. H01M 10/653; H01M 10/658; H01M 50/204; H01M 50/271; H01M 50/293; H01M 50/342

(52) U.S. Cl. CPC H01M 10/653; H01M 10/658; H01M 50/204; H01M 50/271; H01M 50/293; H01M 50/3425

(57) ABSTRACT

A battery pack of the present disclosure includes a pack housing including a base plate and a side wall perpendicular to the base plate; a battery cell assembly on the pack housing; a thermally-decomposable adhesive layer interposed between the battery cell assembly and the base plate; and a flame cover on the battery cell assembly.

### CROSS-REFERENCE TO RELATED APPLICATIONS

This application is based on and claims priority from Korean Patent Application No. 10-2024-0152250, filed on Oct. 31, 2024, with the Korean Intellectual Property Office, the disclosure of which is incorporated herein in its entirety by reference.

### TECHNICAL FIELD

The present disclosure relates to a pack housing and a battery pack including the same.

### BACKGROUND

Unlike primary batteries, secondary batteries are capable of repeated charging and discharging. For this reason and others, secondary batteries are being used widely as energy sources for various wireless devices such as handsets, laptops, and cordless vacuum cleaners. Recently, due to improvements in energy density and economies of scale, the manufacturing cost per unit capacity of secondary batteries has been dramatically reduced, and the driving range of battery electric vehicles (BEVs) has increased to a level comparable to that of fuel-powered vehicles, which has led to a shift in the primary application of secondary batteries from mobile devices to mobility.

The trend in the technological development of secondary batteries for mobility is focused on improving energy density and safety. For example, the safety of secondary batteries for mobility is critically important as it is directly related to the lives of passengers. Reference is made to Korean Laid-Open Patent Publication No. 10-2024-0001662.

### SUMMARY

In view of the foregoing, the present disclosure provides a battery pack with enhanced safety.

Embodiments of the present disclosure provide a battery pack including: a pack housing including a base plate and a side wall perpendicular to the base plate; a battery cell assembly on the pack housing; a thermally-decomposable adhesive layer interposed between the battery cell assembly and the base plate; and a flame cover on the battery cell assembly.

The thermally-decomposable adhesive layer has a decomposition temperature different from the melting point of the flame cover.

The thermally-decomposable adhesive layer has a decomposition temperature lower than the melting point of the flame cover.

The thermally-decomposable adhesive layer has a decomposition temperature ranging from about 200° C. to 300° C.

The flame cover has a melting point of about 300° C. or higher.

The battery cell assembly includes battery cells and thermal separators interposed between the battery cells.

The thermally-decomposable adhesive layer has a decomposition temperature different from the melting point of each of the thermal separators.

The thermally-decomposable adhesive layer has a decomposition temperature lower than the melting point of each of the thermal separators.

Each of the thermal separators has a melting point of about 300° C. or higher.

Two or more of the battery cells are positioned between two adjacent ones of the thermal separators.

The thermal separators alternate with the battery cells.

The thermally-decomposable adhesive layer includes a polymer resin.

The thermally-decomposable adhesive layer includes polyurethane.

The flame cover includes a tear guide on at least one surface.

The pack housing is connected to an exhaust device.

Another embodiment of the present disclosure provides a battery pack housing including: a base plate; at least one side wall connected perpendicularly at an edge of the base plate and defining, together with the base plate, a space in which a battery cell assembly is accommodated; a thermally-decomposable adhesive layer provided on the base plate; and a flame cover provided on an end surface of the side wall so as to face the base plate and cover the space from above.

The thermally-decomposable adhesive layer has a decomposition temperature lower than the melting point of the flame cover.

The thermally-decomposable adhesive layer has a decomposition temperature ranging from about 100° C. to 200° C.

The flame cover has a melting point of about 300° C. or higher.

The flame cover includes a tear guide on at least one surface.

In the battery pack according to an embodiment of the present disclosure, when a thermal runaway event occurs, a battery cell in which a thermal runaway event occurs may be thermally isolated from other battery cells. As a result, the safety of the battery pack may be enhanced.

The effects that may be obtained from the embodiments of the present disclosure are not limited to the effects mentioned above, and other effects not mentioned may be clearly derived and understood by those ordinarily skilled in the art to which the embodiments of the present disclosure belong from the following description. In other words, unintended effects resulting from the implementation of the embodiments of the present disclosure may also be derived by those ordinarily skill in the art from the embodiments of the present disclosure.

### BRIEF DESCRIPTION OF THE DRAWINGS

The following drawings attached hereto illustrate embodiments of the present disclosure and, together with the detailed description to be described later, serve to further understand the technical idea of the present disclosure. Therefore, the present disclosure should not be construed as being limited to the matters illustrated in the drawings.

FIG. 1 is a plan view illustrating a battery pack according to an embodiment of the present disclosure.

FIG. 2 is a cross-sectional view taken along the line 1A-1A′ of FIG. 1.

FIG. 3 is a view illustrating effects of a battery pack according to an embodiment of the present disclosure.

FIG. 4 is a plan view illustrating a battery pack according to another embodiment of the present disclosure.

In some of the attached drawings, corresponding components are given the same reference numerals. Those skilled in the art would appreciate that the drawings depict elements simply and clearly and have not necessarily been drawn to scale. For example, in order to facilitate understanding of various embodiments, the dimensions of some elements illustrated in the drawings may be exaggerated compared to other elements. Additionally, elements of the known art that are useful or essential in commercially viable embodiments may often not be depicted so as not to interfere with the spirit of the various embodiments of the present disclosure.

### DETAILED DESCRIPTION

Hereinafter, embodiments of the present disclosure will be described with reference to the attached drawings. The terms and words used in the specification and claims should not be construed as being limited to their ordinary or dictionary meanings, but should be construed as meanings and concepts consistent with the technical idea of the present disclosure based on a principle that an inventor may appropriately define the concepts of terms in order to explain his or her invention in the best possible manner.

The embodiments in the specification and configurations illustrated in the drawings are merely provided as an example of the present disclosure, and do not represent all the technical ideas of the present disclosure. Therefore, it should be understood that there may be various equivalents and modifications that could replace them at the time of filing this application.

In describing the present disclosure, detailed explanations of related known functions and configurations will be omitted when it is determined that such detailed explanations may obscure the gist of the present disclosure.

The embodiments of the present disclosure are provided to more fully explain the present disclosure to those skilled in the art, and therefore, the shapes, sizes, and other aspects of the components shown in the drawings may be exaggerated, omitted, or schematically illustrated for the sake of clearer explanation. Therefore, the sizes or proportions of the components may not fully reflect their actual sizes or proportions.

The safety of secondary batteries may be achieved through mechanical robustness, reliability of electrical insulation, and a delay in heat transfer in the event of thermal runaway. Thermal runaway refers to a phenomenon in which, once the temperature exceeds a certain level, uncontrollable internal chemical reactions occur, which may lead to explosions or fires. This represents a significant safety issue for secondary batteries, and lithium-ion batteries are particularly vulnerable to thermal runaway.

The present disclosure provides a safer secondary battery by improving safety issues, including thermal runaway, through structural improvements of the pack housing.

### First Embodiment

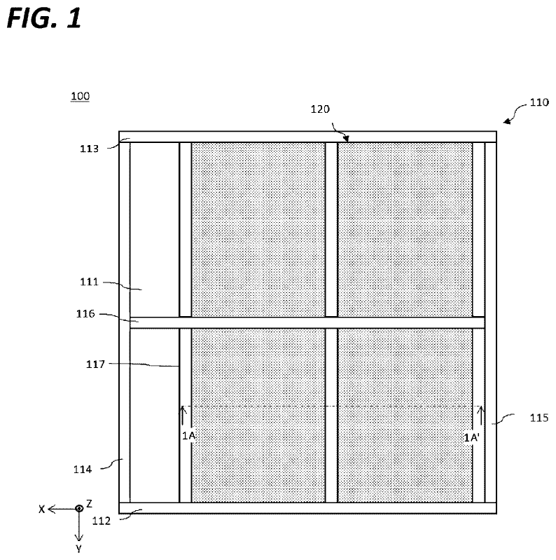

FIG. 1 is a plan view illustrating a battery pack 100 according to an embodiment of the present disclosure.

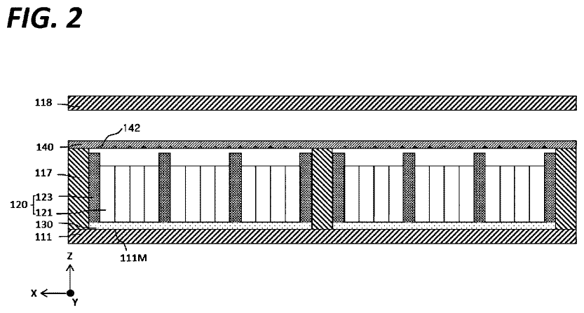

FIG. 2 is a cross-sectional view taken along the line 1A-1A′ of FIG. 1.

Referring to FIGS. 1 and 2, a battery pack 100 according to an embodiment of the present disclosure may include a pack housing 110, battery cell assemblies 120, thermally decomposable adhesive layers 130 (see, e.g., FIG. 2), and a flame cover 140. In FIG. 1, a lead 118 of the pack housing 110 and the flame cover 140 are omitted to illustrate the arrangement among the components of the battery pack 100. The battery pack 100 may be a final product mounted in an application such as a vehicle.

The pack housing 110 may provide a space configured to mount the battery cell assemblies 120 therein. The pack housing 110 may include a bottom plate 111 serving as a base plate, side walls 112, 113, 114, and 115, a center beam 116, cross beams 117, and the lead 118.

Here, two directions substantially parallel to a mounting surface 111M of the bottom plate 111 are defined as an X direction and a Y direction, respectively, and a direction substantially perpendicular to the mounting surface 111M is defined as a Z direction. The X direction, the Y direction, and the Z direction may be substantially perpendicular to each other. The mounting surface 111M may face the battery cell assemblies 120. The bottom plate 111 may have a flat plate shape. The bottom plate 111 may include a metal.

The side walls 112, 113, 114, and 115 may be positioned at the edges of the bottom plate 111. The side walls 112, 113, 114, and 115 may be coupled to the bottom plate 111. The side walls 112, 113, 114, and 115 may be fixed to the bottom plate 111 by methods such as bolting and welding. The side walls 112, 113, 114, and 115 may include a metal. According to an embodiment, the battery cell assemblies 120 are accommodated in a space defined by the bottom plate 111 and the side walls 112, 113, 114, and 115.

The side walls 112 and 113 may be substantially perpendicular to the Y direction. The side walls 112 and 113 may be spaced apart from each other in the Y direction. The side walls 114 and 115 may be substantially perpendicular to the X direction. The side walls 114 and 115 may be spaced apart from each other in the X direction. The side walls 112, 113, 114, and 115 may horizontally surround the battery cell assemblies 120.

The center beam 116 may extend in the X direction. The center beam 116 may be surrounded by the side walls 112, 113, 114, and 115. The center beam 116 may be coupled to the bottom plate 111. The center beam 116 may be fixed to the bottom plate 111 by either welding or bolting. The center beam 116 may include a metal.

Each of the cross beams 117 may extend in the Y direction. The cross beams 117 may be surrounded by the side walls 112, 113, 114, and 115. The cross beams 117 may be coupled to the bottom plate 111. The center beam 116 may be positioned between the cross beams 117. Each of the cross beams 117 may include a metal.

The center beam 116 and the cross beams 117 may isolate the battery cell assemblies 120 from each other. The battery cell assemblies 120 may be spaced apart from each other in the Y direction with the center beam 116 interposed therebetween. The center beam 116 may be interposed between the battery cell assemblies 120. The battery cell assemblies 120 may be spaced apart from each other in the X direction with the cross beams 117 interposed therebetween. The cross beams 117 may be interposed between the battery cell assemblies 120.

In FIG. 1, the arrangement of the battery cell assemblies 120 may be described as a 2×2 arrangement. The arrangement of the battery cell assemblies 120 illustrated in FIG. 1 is a non-limiting example and does not limit the technical spirit of the present disclosure in any way. A person skilled in the art would readily appreciate, based on the description provided herein, that the battery cell assemblies 120 may be arranged in an M×N arrangement (where M and N are each integers of 1 or more).

The lead 118 may cover components mounted inside the battery pack 100, such as the battery cell assemblies 120 and electrical components. The lead 118 may be fixed to the side walls 112, 113, 114, and 115 by mechanical fastening means, such as bolting. According to an embodiment, a gasket may be further provided between the lead 118 and the side walls 112, 113, 114, and 115, so that liquid-tightness of the battery pack 100 may be ensured.

The battery cell assemblies 120 may be accommodated on the bottom plate 111. Each of the battery cell assemblies 120 may include battery cells 121 and thermal separators 123. Each of the battery cell assemblies 120 may further include first and second integrated circuit assemblies and a flexible flat cable (FFC) assembly connecting the circuit assemblies.

Each of the battery cells 121 may include an electrode assembly, an electrolyte, and a case. Each of the battery cells 121 may be one of a cylindrical battery cell, a prismatic battery cell, or a pouch-type battery cell. The electrode assembly of the cylindrical battery cell is housed in a cylindrical metal can. The electrode assembly of the prismatic battery cell housed in a prismatic metal can. The electrode assembly of the pouch-type battery cell is housed in a pouch case including an aluminum laminate sheet.

Each electrode assembly includes a positive electrode, a negative electrode, and a separator interposed between the positive electrode and the negative electrode. A jelly-roll type electrode assembly includes a wound structure of the positive electrode, the negative electrode, and the separator interposed therebetween. A stacked type electrode assembly includes a plurality of stacked positive electrodes, a plurality of negative electrodes, and a plurality of separators, all of which are sequentially stacked, in which the separators are interposed between the positive and negative electrodes.

According to the embodiment, the battery cells 121 may form a plurality of banks. Each of the banks may include one or more battery cells connected in parallel. The banks may be connected to each other in series. The number of battery cells included in each of the banks and the number of banks connected in series may be determined according to the voltage and current to be output through each of the battery cell assemblies 120.

According to the embodiment, each of the thermal separators 123 may be positioned between battery cells 121. According to the embodiment, two or more of the battery cells 121 may be positioned between two adjacent thermal separators 123.

FIG. 2 illustrates that four battery cells 121 form a sub-group, and the sub-groups of battery cells 121 and the thermal separators 123 are alternately arranged. However, this is provided as an example and does not limit the technical spirit of the present disclosure in any way. For example, one bank or two banks may be positioned between adjacent thermal separators 123. Alternatively, each battery cell 121 may be configured in a structure in which the battery cell 112 is sandwiched between two thermal separators 123 on both sides, as needed.

According to the embodiment, the thermal separators 125 may be configured to delay or prevent the propagation of a thermal runaway event that occurs in one group of the battery cells 121 to another group, by dividing the battery cells 121 into two or more groups. Here, thermal runaway refers to an uncontrollable positive feedback condition in which a temperature change of the battery cells 121 further accelerates the temperature increase. The battery cells 121 in a thermal runaway state exhibit a rapid temperature rise and release a large amount of high-pressure gas and combustion residues.

According to the embodiment, each of the thermal separators 123 may have a high melting point. According to the embodiment, each of the thermal separators 123 may have a low thermal conductivity.

According to the embodiment, the melting point of each of the thermal separators 123 may be about 300° C. or higher. According to the embodiment, the melting point of each of the thermal separators 123 may be about 600° C. or higher. According to the embodiment, the melting point of each of the thermal separators 123 may be about 1,000° C. or higher. According to the embodiment, the melting point of each of the thermal separators 123 may be 1,500° C. or higher.

According to the embodiment, the thermal conductivity of each of the thermal separators 123 may be about 20 W/mK or less. According to the embodiment, the thermal conductivity of each of the thermal separators 123 may be about 1 W/mK or less. According to the embodiment, the thermal conductivity of each of the thermal separators 123 may be about 0.3 W/mK or less. The thermal conductivity of each of the thermal separators 123 described above may be measured at room temperature (about 25° C.).

According to the embodiment, each of the thermal separators 123 may include a ceramic material such as aluminum oxide (alumina), magnesium oxide (magnesia), silicon dioxide (silica), silicon nitride, silicon carbide (carborundum), or aluminosilicate. According to the embodiment, each of the thermal separators 123 may include one of calcium silicate, calcium magnesium silicate, or aramid. According to the embodiment, each of the thermal separators 123 may include glass fiber coated with, for example, one of silicon, acrylic, vermiculite, graphite, and polytetrafluoroethylene (PTFE).

According to the embodiment, each of the thermal separators 123 may further include a compressible material. According to the embodiment, each of the thermal separators 123 may absorb swelling of the battery cells 121.

The battery pack 100 according to an embodiment of the present disclosure includes a first integrated circuit assembly. The first integrated circuit assembly may include an insulating frame, an integrated circuit, bus bars, wires, and an insulating cover. The integrated circuit assembly may include physical and functional configurations for providing electrical connections between the battery cells 121, outputting the resulting voltage of the battery cells 121, and measuring voltages (or currents) at nodes inside the circuit formed by the battery cells 121.

The insulating frame may include an insulating material such as plastic. The insulating frame may cover the front side of the battery cells 121. The insulating frame may support the integrated circuit, the bus bars, and the wires.

The bus bars may be shorted to the positive leads of the battery cells of the first bank and to the negative leads of one or more battery cells of the last bank. The bus bars may be welded to the positive leads of the battery cells of the first bank and to the negative leads of one or more battery cells of the last bank. Through the bus bars, the resulting voltage of the battery cells 121 of each of the battery cell assemblies 120 may be output. The bus bars may be fixed to the insulating frame.

The integrated circuit may be mounted on the insulating frame. The welded positive leads and negative leads may form internal nodes of each of the battery cell assemblies 120. The integrated circuit may be configured to measure voltages of the nodes through sensing plates and sensing bars.

The sensing bars may include a conductive material. The sensing bars may have a rod shape. The sensing bars may be shorted to the bus bars. The sensing bars may be coupled to the bus bars. Through the sensing bars, voltages of the bus bars may be measured.

Each of the sensing plates may have a patch shape or a pad shape. The sensing plates may include a conductive material. The sensing plates may be shorted to corresponding ones of the positive and negative leads of the battery cells 121.

Each of the sensing plates may be connected to the integrated circuit. Through the sensing plates, voltages of a plurality of nodes inside the battery cell assemblies 120 may be measured.

The insulating cover may include an insulating material such as plastic. The insulating cover may be fitted to the insulating frame. The insulating cover may cover the integrated circuit and the bus bars, so that the electrical components of the first and second integrated circuit assemblies may be protected.

The battery pack 100 according to an embodiment of the present disclosure includes a second integrated circuit assembly. The second integrated circuit assembly may include an insulating frame, an integrated circuit, wires, bus bars, and an insulating cover. The second integrated circuit assembly is substantially the same as the first integrated circuit assembly, except that it does not include the bus bars.

The thermally decomposable adhesive layers 130 may be positioned between the battery cell assemblies 120 and the bottom plate 111. The thermally decomposable adhesive layers 130 may be in contact with the battery cell assemblies 120 and the bottom plate 111. The thermally decomposable adhesive layers 130 may fix the battery cell assemblies 120 to the bottom plate 111. According to the embodiment, the thermally decomposable adhesive layers 130 may mediate heat transfer between the battery cell assemblies 120 and the bottom plate 111 within a normal temperature range. The thermally decomposable adhesive layers 130 may decompose when exposed to high-temperature conditions, such as a thermal runaway event.

The decomposition temperature of each of the thermally decomposable adhesive layers 130 may be different from the melting point of each of the thermal separators 123. The decomposition temperature of each of the thermally decomposable adhesive layers 130 may be lower than the melting point of each of the thermal separators 123.

Each of the thermally decomposable adhesive layers 130 may include a base resin (Part A), a curing agent (Part B), a dispersant, and an inorganic filler. The thermally decomposable adhesive layers 130 may further include viscosity modifiers such as a thixotropy agent, a diluent, a surface treatment agent, and a coupling agent. The thermally decomposable adhesive layers 130 may be a room-temperature curable composition. That is, the curing reaction of the thermally decomposable adhesive layers 130 may initiate and proceed at room temperature.

The base resin of each of the thermally decomposable adhesive layers 130 may include a thermosetting resin. The base resin of each of the thermally decomposable adhesive layers 130 may include a thermoplastic resin. The base resin of each of the thermally decomposable adhesive layers 130 may include a polymer resin. The base resin of the thermally decomposable adhesive layers 130 may include polyurethane. When the base resin of the thermally decomposable adhesive layers 130 is polyurethane, the decomposition temperature of each of the thermally decomposable adhesive layers 130 may be in a range of about 100° C. to about 200° C. The thermally decomposable adhesive layers 130 may also include any resin that decomposes in a temperature range of about 100° C. to about 200° C.

The curing agent of each of the thermally decomposable adhesive layers 130 may be selected according to the base resin of each of the thermally decomposable adhesive layers 130. For example, when the base resin of each of the thermally decomposable adhesive layers 130 is polyurethane, the curing agent may include an isocyanate such as methylene diphenyl diisocyanate, toluene diisocyanate, hexamethylene diisocyanate, or polymeric methylene diphenyl diisocyanate.

The inorganic filler of each of the thermally decomposable adhesive layers 130 may have relatively high thermal conductivity. According to the embodiment, the thermal conductivity of the inorganic filler of each of the thermally decomposable adhesive layers 130 may be about 1 W/mK or higher. According to the embodiment, the thermal conductivity of the inorganic filler of each of the thermally decomposable adhesive layers 130 may be 5 W/mK or higher. According to the embodiment, the thermal conductivity of the inorganic filler of each of the thermally decomposable adhesive layers 130 may be 10 W/mK or higher. According to the embodiment, the thermal conductivity of the inorganic filler of each of the thermally decomposable adhesive layers 130 may be about 15 W/mK or higher.

According to the embodiment, each of the thermally decomposable adhesive layers 130 may include a ceramic as the inorganic filler. For example, the inorganic filler of each of the thermally decomposable adhesive layers 130 may include one of aluminum oxide (Al₂O₃), aluminum nitride (AlN), boron nitride (BN), silicon nitride (Si₃N₄), silicon carbide (SiC), beryllium oxide (BeO), zinc oxide (ZnO), aluminum hydroxide (Al(OH)₃), and boehmite. Each of the thermally decomposable adhesive layers 130 may also include a carbon filler. Each of the thermally decomposable adhesive layers 130 may further include, for example, one of fumed silica, clay, and calcium carbonate.

The dispersant of each of the thermally decomposable adhesive layers 130 may improve the dispersibility of the inorganic filler of each of the thermally decomposable adhesive layers 130. The inorganic filler may be uniformly dispersed by the dispersant.

The flame cover 140 may be installed on the battery cell assemblies 120 and the cross beams 117. The flame cover 140 may be fixed to the cross beams 117 by an adhesive layer or bolting. FIG. 2 illustrates that the battery cell assemblies 120 are covered by a single flame cover 140, but the present disclosure is not limited thereto. For example, two battery cell assemblies 120 may be covered by a single flame cover 140, or each of the battery cell assemblies 120 may be covered by a separate flame cover 140.

According to the embodiment, each of the thermal separators 123 may have a high melting point. According to the embodiment, each of the thermal separators 123 may have a low thermal conductivity.

The flame cover 140 may include tear guides 142 on at least one surface. Each of the tear guides may be formed by a non-through cutting process of the flame cover 140 using, for example, a knife. The tear guides may allow the portion of the flame cover 140 where the tear guides are formed to be easily fractured when a thermal runaway event occurs, thereby providing a venting path.

According to the embodiment, the melting point of the flame cover 140 may be about 300° C. or higher. According to the embodiment, the melting point of the flame cover 140 may be about 600° C. or higher. According to the embodiment, the melting point of the flame cover 140 may be about 1,000° C. or higher. According to the embodiment, the melting point of the flame cover 140 may be 1,500° C. or higher.

The decomposition temperature of each of the thermally decomposable adhesive layers 130 may be different from the melting point of the flame cover 140. For example, the decomposition temperature of each of the thermally decomposable adhesive layers 130 may be lower than the melting point of the flame cover 140.

According to the embodiment, the thermal conductivity of the flame cover 140 may be about 20 W/mK or less. According to the embodiment, the thermal conductivity of the flame cover 140 may be about 1 W/mK or less. According to the embodiment, the thermal conductivity of the flame cover 140 may be about 0.3 W/mK or less. The thermal conductivity of the flame cover 140 described above may be measured at room temperature (about 25° C.).

According to the embodiment, the flame cover 140 may include a ceramic material such as aluminum oxide (alumina), magnesium oxide (magnesia), silicon dioxide (silica), silicon nitride, silicon carbide (carborundum), or aluminosilicate. According to the embodiment, the flame cover 140 may include one of calcium silicate, calcium magnesium silicate, and aramid. According to the embodiment, the flame cover 140 may include glass fiber coated with one of silicon, acrylic, vermiculite, graphite, or polytetrafluoroethylene (PTFE). According to the embodiment, the flame cover 140 may include mica.

The battery pack may further include exhaust devices coupled to the pack housing 110. The pack housing 110 may include exhaust holes connected to the exhaust devices. When a thermal runaway event occurs in the battery cell assemblies 120, the exhaust devices may be configured to delay heat propagation by discharging high-temperature gas inside the battery pack 100 to the outside.

The battery pack 100 may further include a battery management system (BMS). The BMS may be configured to perform monitoring, balancing, and control of the battery pack 100. Monitoring of the battery pack 100 may include measuring voltages and currents at specific nodes inside the battery cell assemblies 120 and measuring temperatures at predetermined positions inside the battery pack 100. The battery pack 100 may include measuring instruments configured to measure the voltages, currents, and temperatures described above.

Balancing of the battery pack 100 refers to an operation that reduces deviations among the battery cell assemblies 120. Control of the battery pack 100 includes preventing or suppressing the occurrence of over-charging, over-discharging, and over-current. Through the monitoring, balancing, and control, the battery pack 100 may operate under optimal conditions, thereby preventing or suppressing shortening of the lifespan of each of the battery cell assemblies 120.

The battery pack 100 may further include additional electrical components such as a cooling device, a power relay assembly (PRA), and a safety plug. The cooling device may include a cooling fan. The cooling fan may prevent or suppress overheating of each of the battery cell assemblies 120 by circulating air inside the battery pack 100. The PRA may be configured to supply or cut off power from the high-voltage battery to an external load (e.g., a vehicle motor). The PRA may protect the battery cell assemblies 120 and an external load (e.g., a vehicle motor) by cutting off the power supply to the external load when an abnormal voltage, such as a voltage surge, occurs.

The battery pack 100 may further include a plurality of inter-bus bars configured to electrically connect the battery cell assemblies 120. The battery cell assemblies 120 may be connected in series via the plurality of inter-bus bars. Accordingly, the battery pack 100 may be configured to output a high voltage to an external load (e.g., a vehicle motor).

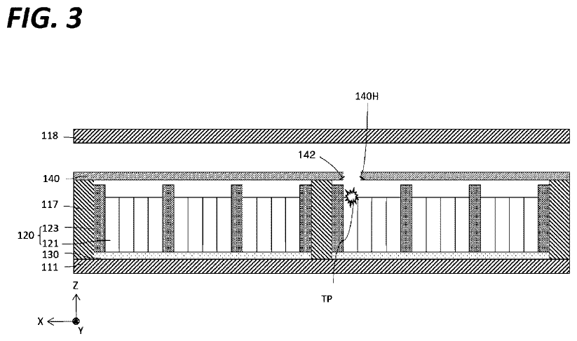

FIG. 3 is a view illustrating the thermal runaway blocking effect of the battery pack 100 according to an embodiment of the present disclosure.

Referring to FIGS. 1 to 3, a thermal runaway event TP may occur in some of the battery cells 121. The portion of the flame cover 140 where the tear guide 142 overlaps a battery cell 121 in which a thermal runaway event TP occurs may be fractured, so that a venting hole 140H may be formed. According to the embodiment, a portion of the thermally decomposable adhesive layer 130 adjacent to the battery cell 121 in which the thermal runaway event TP occurs may decompose, so that heat propagation through the bottom plate 111 may be mitigated or blocked. In addition, the thermal separators 123 and the flame cover 140 may isolate the battery cell 121 in which the thermal runaway event TP occurs, or the sub-group of battery cells 121 in which the event occurs, from the other battery cells 121, and may block or delay heat propagation.

### Second Embodiment

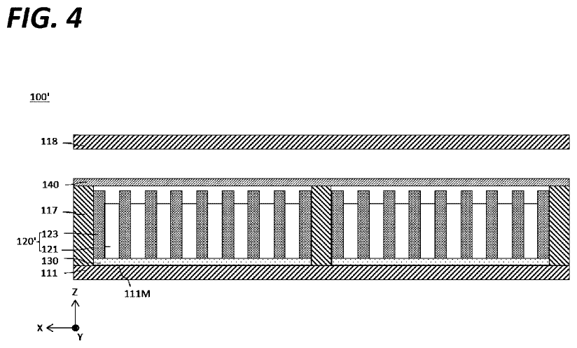

FIG. 4 is a plan view illustrating a battery pack 100′ according to another embodiment of the present disclosure.

Referring to FIG. 4, the battery pack 100′ may include a pack housing 110, battery cell assemblies 120′, thermally decomposable adhesive layers 130, and a flame cover 140. Since the pack housing 110, the thermally decomposable adhesive layers 130, and the flame cover 140 are substantially the same as those described with reference to FIGS. 1 to 3, repeated descriptions thereof will be omitted. In addition, some elements are omitted to illustrate the arrangement among the components of the battery pack 100′. The battery pack 100 may be a final product mounted in an application such as a vehicle.

Each of the battery cell assemblies 120 may include battery cells 121 and thermal separators 123. Each of the battery cell assemblies 120 may further include first and second integrated circuit assemblies and an FFC assembly connecting the circuit assemblies.

The battery cell assemblies 120′ may be substantially the same as the battery cell assemblies 120 of FIGS. 1 and 2, except for the arrangement of the battery cells 121 and the thermal separators 123.

In FIG. 4, the battery cells 121 and the thermal separators 123 may alternate in the X direction. One of the thermal separators 123 may be positioned between two adjacent battery cells 121. One of the battery cells 121 may be positioned between two adjacent thermal separators 123. Due to such a structure, in the embodiment of FIG. 4, the number of thermal separators 123 is greater than the number of battery cells 121, and each of the battery cells 121 is separated by the thermal separators 123, so that the safety of the battery pack 100′ may be further enhanced.

In the foregoing, the present disclosure has been described in detail with reference to the drawings and embodiments. However, the embodiments described in this specification and the configurations illustrated in the drawings are merely embodiments of the present disclosure, and do not represent all the technical ideas of the present disclosure. Therefore, it should be understood that, at the time of filing, there may be various equivalents and modifications that could serve as alternatives to the embodiments.

What is claimed is:

1. A battery pack comprising:
a pack housing including a base plate and a side wall perpendicular to the base plate;
a battery cell assembly on the pack housing;
a thermally-decomposable adhesive layer interposed between the battery cell assembly and the base plate; and
a flame cover on the battery cell assembly.

2. The battery pack according to claim 1, wherein the thermally-decomposable adhesive layer has a decomposition temperature different from a melting point of the flame cover.

3. The battery pack according to claim 1, wherein the thermally-decomposable adhesive layer has a decomposition temperature lower than a melting point of the flame cover.

4. The battery pack according to claim 1, wherein the thermally-decomposable adhesive layer has a decomposition temperature ranging from about 100° C. to 200° C.

5. The battery pack according to claim 1, wherein the flame cover has a melting point of about 300° C. or higher.

6. The battery pack according to claim 1, wherein the battery cell assembly includes battery cells and thermal separators interposed between the battery cells.

7. The battery pack according to claim 6, wherein the thermally-decomposable adhesive layer has a decomposition temperature different from a melting point of each of the thermal separators.

8. The battery pack according to claim 6, wherein the thermally-decomposable adhesive layer has a decomposition temperature lower than a melting point of each of the thermal separators.

9. The battery pack according to claim 6, wherein each of the thermal separators has a melting point of about 300° C. or higher.

10. The battery pack according to claim 6, wherein two or more of the battery cells are positioned between two adjacent ones of the thermal separators.

11. The battery pack according to claim 6, wherein the thermal separators alternate with the battery cells.

12. The battery pack according to claim 1, wherein the thermally-decomposable adhesive layer includes a polymer resin.

13. The battery pack according to claim 1, wherein the thermally-decomposable adhesive layer includes polyurethane.

14. The battery pack according to claim 1, wherein the flame cover includes a tear guide on at least one surface.

15. The battery pack according to claim 1, wherein the pack housing is connected to an exhaust device.

16. A battery pack housing comprising:
a base plate;
at least one side wall connected perpendicularly at an edge of the base plate and defining, together with the base plate, a space in which a battery cell assembly is accommodated;
a thermally-decomposable adhesive layer provided on the base plate; and
a flame cover provided on an end surface of the side wall so as to face the base plate and cover the space from above.

17. The battery pack housing according to claim 16, wherein the thermally-decomposable adhesive layer has a decomposition temperature lower than a melting point of the flame cover.

18. The battery pack housing according to claim 16, wherein the thermally-decomposable adhesive layer has a decomposition temperature ranging from about 100° C. to 200° C.

19. The battery pack housing according to claim 16, wherein the flame cover has a melting point of about 300° C. or higher.

20. The battery pack housing according to claim 16, wherein the flame cover includes a tear guide on at least one surface.
